(19) United States
(12) Patent Application Publication
(10) Pub. No.: US 2017/0278089 A1
(43) Pub. Date: Sep. 28, 2017

(54) Mobile-Friendly Internet Banking Checkouts

(71) Applicant: International Business Machines Corporation, Yorktown Heights, NY (US)

(72) Inventors: Ravi Kothari, Bangalore (IN); Apurva Kumar, Bangalore (IN)

(21) Appl. No.: 15/082,606

(22) Filed: Mar. 28, 2016

(51) Int. Cl. G06Q 20/32; G06Q 20/02; G06Q 20/40; G06Q 20/36; G06Q 20/38

(52) U.S. Cl. CPC G06Q 20/3223; G06Q 20/36; G06Q 20/385; G06Q 20/40; G06Q 20/027

(57) ABSTRACT

Methods, systems, and computer program products for mobile-friendly Internet banking checkouts are provided herein. A computer-implemented method includes displaying, to a user, a collection of one or more user device identifiers; verifying that a user-selected one of the user device identifiers is linked to a user device that is in the possession of the user; and linking the verified user-selected user device identifier to a payment account identifier attributed to the user by (i) matching the user-selected user device identifier to a user device identifier stored in connection with the payment account, and (ii) executing a transaction of the user over the Internet via the payment account.

### FIELD

The present application generally relates to information technology, and, more particularly, to Internet banking.

### BACKGROUND

Internet banking (also referred to herein as “net-banking”) is an increasingly-preferred mode for completing online payments in one or more parts of the world. Unlike the utilization of credit and/or debit cards, Internet banking commonly does not involve sharing payment credentials (such as a credit card number, a card verification value (CVV), expiry date, etc.) with the merchant or payment gateway. Additionally, Internet banking is often utilized for online settlement of a customer's bill (such as a credit card bill or a loan repayments) due to other banks and/or financial institutions.

However, existing Internet banking payment workflows are often not compatible with many modern payment systems that use mobile devices and digital wallets due to usability and/or security concerns.

### SUMMARY

In one embodiment of the present invention, techniques for implementing mobile-friendly Internet banking checkouts are provided. An exemplary computer-implemented method can include steps of displaying, to a user, a collection of one or more user device identifiers; verifying that a user-selected one of the user device identifiers is linked to a user device that is in the possession of the user; and linking the verified user-selected user device identifier to a payment account identifier attributed to the user by (i) matching the user-selected user device identifier to a user device identifier stored in connection with the payment account, and (ii) executing a transaction of the user over the Internet via the payment account.

In another embodiment of the invention, an exemplary computer-implemented method can include presenting, to a user, a collection of one or more stored user device identifiers, and verifying that a user-selected one of the user device identifiers is linked to a user device that is in the possession of the user. The method can also include linking the verified user-selected user device identifier to a payment account identifier attributed to the user by (i) matching the user-selected user device identifier to a user device identifier stored in connection with the payment account, and (ii) executing a first transaction, between the user and one of multiple merchants, over the Internet via the payment account. Additionally, the method can include denoting the payment account linked to the verified user-selected user device identifier as an expedited payment mechanism for use in one or more future transactions with one or more of the multiple merchants, and providing the expedited payment mechanism as a payment option in connection with a second transaction between the user and one of the multiple merchants.

Another embodiment of the invention or elements thereof can be implemented in the form of an article of manufacture tangibly embodying computer readable instructions which, when implemented, cause a computer to carry out a plurality of method steps, as described herein. Furthermore, another embodiment of the invention or elements thereof can be implemented in the form of an apparatus including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an exemplary embodiment of the invention;

FIG. 2 is a diagram illustrating system architecture, according to an exemplary embodiment of the invention;

FIG. 3 is a flow diagram illustrating techniques according to an embodiment of the invention; and

FIG. 4 is a system diagram of an exemplary computer system on which at least one embodiment of the invention can be implemented.

### DETAILED DESCRIPTION

As described herein, an embodiment of the present invention includes mobile-friendly Internet banking checkouts. At least one embodiment of the invention includes providing a scheme for Internet banking payments that overcomes usability and security issues of existing approaches by, for example, precluding the need for redirection to a bank, precluding the need for authentication with the bank or a digital wallet service within a Web view and/or an in-application browser, and precluding sharing or compromising sensitive information such as an account number, a password, etc. As detailed herein, one or more embodiments of the invention include utilizing a customer's phone number to create a virtual wallet that simplifies as well as secures payments.

Accordingly, at least one embodiment of the invention includes implementing a mobile-friendly payment scheme that works across multiple banks without the requirement of an additional identifier or dedicated infrastructure (centralized or decentralized) for mapping an additional identifier to an actual account. As further described herein, such an embodiment includes directly mapping a customer's (mobile) phone number to a bank account. Additionally, and as further detailed herein, one or more embodiments of the invention include automatically registering one or more bank account instruments associated with a (mobile) phone number in a virtual wallet supported by the gateway. Further, at least one embodiment of the invention includes providing a mechanism for a payment gateway to uniquely identify a bank account without needing to store sensitive information such as an account number. Also, an example embodiment of the invention can be implemented within the context of a set of participating retailers that use a payment gateway enabled with one or more of the features described herein.

One or more embodiments of the invention include enabling a user (for example, via a participating retailer) to identify one of the user's (mobile) phone numbers to be used in connection with checkouts and payments. A verification technique can subsequently be implemented (for example, via the retailer) to verify that the phone is indeed in the possession of the user. By way of example, the verification technique can include challenging the user to provide a one-time password sent to the (mobile) phone number.

Instead of having the possession of the device being verified at least once by all participating retailers, one or more embodiments of the invention can include carrying out the verification via the gateway at the time of payment itself. In such an embodiment, any retailer (regardless of whether the retailer has performed the verification of a customer's registered mobile number) can be a participating retailer.

Additionally, at least one embodiment of the invention can include linking the identified (mobile) phone number to an account number that can be enabled by making a first (successful) payment at one of the participating retailers using a bank account that is associated with the same (mobile) phone number. In one or more embodiments of the invention, the gateway passes the bank account information/number to the bank, and the bank checks whether the number matches with the phone number against the bank account that is used for the first payment.

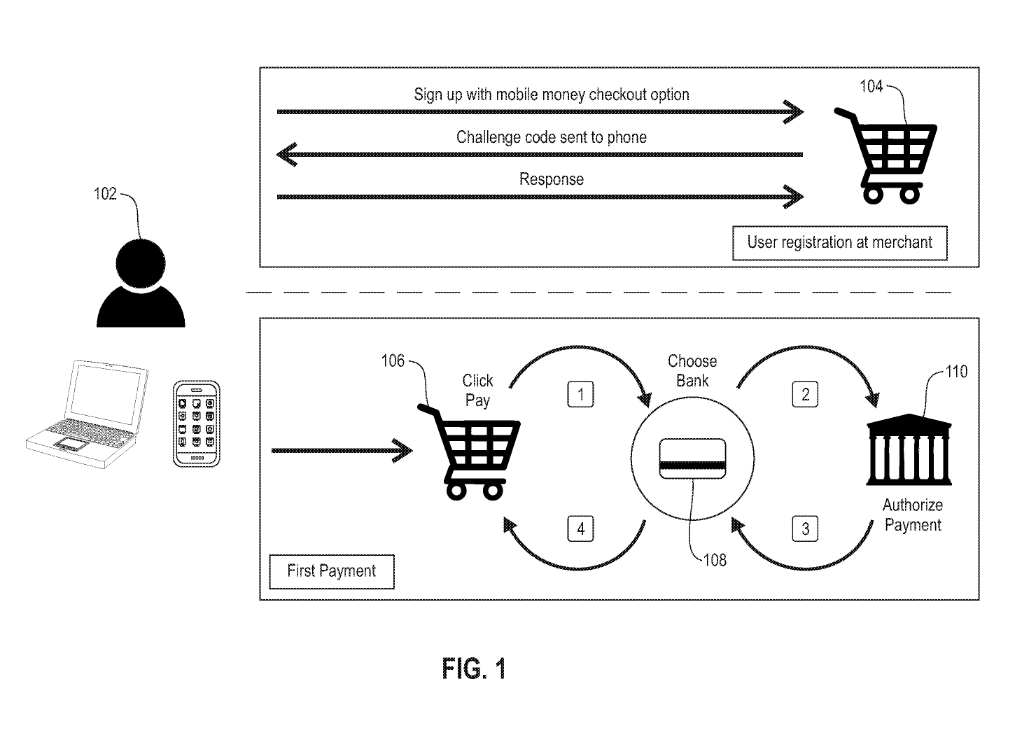

FIG. 1 is a diagram illustrating system architecture, according to an embodiment of the invention. By way of illustration, FIG. 1 depicts a user (and corresponding user devices such as a mobile phone) 102, a (retail) merchant 104, a (retail) checkout 106, a payment gateway 108 and a financial institution (such as a bank) 110. Specifically, FIG. 1 is a diagram illustrating system architecture in connection with a first payment process. Also illustrated in FIG. 1 is a process of verifying possession of a mobile device corresponding to the user's mobile number registered at the merchant. Such a process can be performed prior to the first payment process (for example, when the user 102 signs-up with the merchant 104 for a mobile money checkout option). In an example embodiment of the invention, such as depicted in FIG. 1, such a verification process can be performed by the merchant 104 sending a challenge code to the user's phone, and thereafter the user 102 responding to the merchant 104 with the provided challenge code to verify possession of the user's phone.

Additionally, as depicted in FIG. 1, the user 102 also carries out a first payment process, as illustrated via steps 1-4. In step 1, the user 102 (via the user's mobile phone, for example) initiates the payment process (for example, by clicking a “pay” button on the merchant's online checkout 106), and in the redirect from the merchant checkout 106 to the payment gateway 108, any phone number registered for mobile money (such as the user's mobile phone number) is included. In step 2, as illustrated in FIG. 1, in the redirect from gateway 108 to the bank 110, the phone number is included as an additional field.

Additionally, when redirected to the bank site, the user can log-in to the bank site, select a bank account, and authorize payment. Such actions can occur, for example, between steps 2 and 3 of FIG. 1. Further, in step 3, as illustrated in FIG. 1, when the bank 110 redirects back to the gateway 108, the bank 110 includes an identifier and/or a reference to a bank account (or a credit or debit card account) used for payment if the phone number registered for the account was the same as the phone number sent in step 2. In step 4, the gateway 108 saves this association if the user 102 chooses to enable mobile money payments for the account, and the gateway also allows the user 102 to specify a name for the association (for ease of future use and/or recognition, for example).

Accordingly, while redirecting the user's browser to the chosen bank 110 during this first payment, the gateway 108 includes the user's (verified) phone number at the merchant 104 in the authorization request. If the user 102 successfully authorizes the payment and the phone number in the request is the same as the user's registered phone number for the bank account used for the payment, the bank 110 returns a unique identifier for the account in the redirection request back to the payment gateway 108. The payment gateway 108 can subsequently query the user 102 whether the user 102 would like the noted bank account to be remembered to enable quick checkout. In one or more embodiments of the invention, a default name can be given to the account, which the user can subsequently change. Additionally, in such an embodiment, the gateway 108 associates the account identifier (such as received in step 3 illustrated in FIG. 1) with this account name. Note that the first payment process does not itself avoid redirection to the bank website. However, the first payment process ensures that subsequent payments using the same bank account can be privacy-preserving and secure through both the web and mobile channels.

Additionally, it should be noted that the actual workflow used may be different depending on the available interfaces provided by the banks and payment networks. Accordingly, one or more embodiments of the invention can include adapting the workflow to incorporate the mobile number-based linking of user accounts as described above.

In at least one embodiment of the invention, the first payment process described above and depicted in FIG. 1 can be repeated each time the user makes an Internet banking payment at a participating retailer using a bank account for the first time.

If the user has chosen to remember one or more bank accounts (such as in step 4, as illustrated in FIG. 1), apart from standard credit card and/or debit card options, the gateway provides an option of checking out using a mobile number (wherein such an option is also referred to herein as a mobile money checkout option). At least one embodiment of the invention, as detailed herein, can include optimizing such an option for a mobile implementation. In such an embodiment, the retailer/merchant can choose to display the option only during mobile app checkouts. Upon selecting (via clicking on related button/prompt, for example) the option, the user is presented with a list of possible bank accounts identified by names chosen by the user (as detailed in step 4 of FIG. 1, for example).

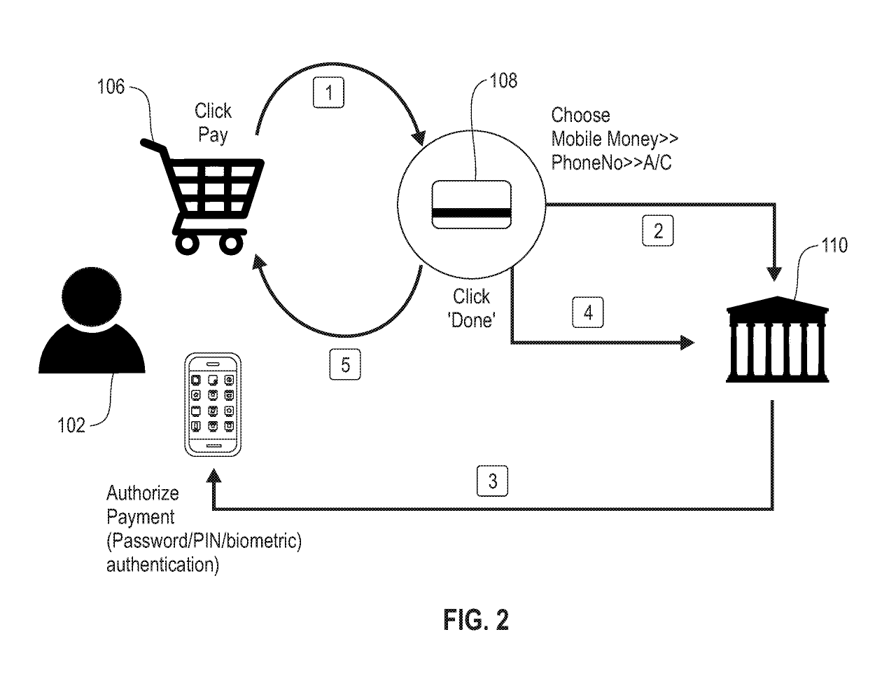

FIG. 2 is a diagram illustrating system architecture, according to an exemplary embodiment of the invention. Specifically, FIG. 2 is a diagram illustrating system architecture in connection with a subsequent (mobile-friendly) payment process (that is, subsequent to the first payment process illustrated in connection with FIG. 1). By way of illustration, and similar to FIG. 1, FIG. 2 depicts the user 102, the merchant (retailer) checkout 106, the payment gateway 108, and a financial institution (such as a bank) 110. As noted, the gateway 108 and the bank 110 in FIG. 2 are the same that were involved in the workflow of FIG. 1, while the retailer 106 can be the same as in FIG. 1 or any other participating retailer.

Additionally, as depicted in FIG. 2 (and in conjunction with FIG. 1), the user 102 carries out a subsequent payment process, as illustrated via steps 1-5. In step 1, as illustrated in FIG. 2, upon clicking a “pay” button via the merchant's online checkout 106, the user 102 is redirected to the gateway 108. In step 2, as further depicted in FIG. 2, after the user 102 chooses to pay using a mobile money checkout option and selects a particular bank and account number with which to carry out that mobile money transaction, an authorization request is sent to the bank 110 with an account reference and/or identifier.

Further, in step 3, as illustrated in FIG. 2, the bank 110 sends an authorization request and notification to the bank app installed on the user's mobile phone 102. In step 4, once the user 102 authorizes using the bank app and concludes the transaction (clicks “done,” for example) on merchant app and/or website, the gateway 108 confirms with the bank 110 that the payment has been authorized. The curved arrow denoted as step 5 in FIG. 2 signifies confirmation of the payment from the gateway 108 back to the retailer 106.

Accordingly, as depicted in FIG. 1, upon choosing one of the accounts (for example, MyACCT), instead of redirecting the user 102 to the corresponding bank 110, an application programming interface (API) request for authorization is sent from the gateway 108 to the bank 110. Such a request can include transaction details and an identifier for the chosen account. Additionally, as noted above, the user is requested to complete the authorization on the bank app, for example, by clicking a designated button (such as “Done,” for instance).

The bank 110 can further send a notification to the bank's app installed on the user's phone 102. The user 102 can additionally be presented with a request for debiting his or her account corresponding to the account name (MyACCT, for example). The user 102 can then authorize the request/transaction, and in the process, the user 102 can authenticate with the bank 110 using his or her internet banking password. Once the authorization is complete, the user can (as noted above) conclude the transaction (for example, by clicking a “Done” button/prompt) on the merchant app or website. The gateway 108 then verifies with the bank 110 that the payment has been authorized, and confirms the same to the merchant. The merchant app or website can then show the order confirmation page to the user 102.

In one or more additional embodiments of the invention, possession of the phone can also be verified by the gateway rather than individual retailers. For example, it is possible to include this verification before step 1 in FIGS. 1 and 2 (on user-selection of the user device identifier). One means of carrying out the action can include making the user click a pop-up confirmation screen on the device whose possession is to be verified. The pop-up can be generated on the user's phone using mobile operator services such as Unstructured Supplementary Service Data (USSD) push or a subscriber identity module (SIM) based authorization service. Such an action can also be based on sending notification messages using a notification service provided by the device operating system (OS) provider.

It should be noted that the methods described herein are not restricted to a particular type of payment method. For example, one or more embodiments of the invention can include implementation with online payments using debit cards and credit cards. Moreover, the techniques detailed herein require that whatever type of payment instrument utilized is associated with a mobile number of the user.

Additionally, one or more embodiments of the invention can include merging bank account instruments with a digital wallet already existing on a user device. Additionally, in connection with at least one embodiment of the invention, mapping a mobile number to a list of payment instruments during checkout is not limited to bank accounts. Such mapping can also be implemented to include other instruments such as credit cards, debit cards, etc.

Accordingly, as detailed in connection with FIG. 1 and FIG. 2, one or more embodiments of the invention can include utilizing an association of a customer's/user's mobile phone number with one or more payment account numbers, and using the association to initiate checkouts via the user providing a mobile number at a merchant and/or gateway. Further, such an embodiment can also include implementing a mechanism wherein a customer's previous payment using the particular payment instrument is used to establish the association. Additionally, at least one embodiment of the invention can include implementing a virtual wallet that is capable of auto-registering bank account payment instruments without needing to store sensitive information such as payment account details.

In connection with one or more embodiments of the invention, an explicit login is not required to view and/or choose payment options against a phone number, nor is a login required for initiating a routing authorization request to a bank. Instead, such an embodiment includes using an assertion of a validated phone number from the merchant for identifying the user at the gateway and/or wallet service. Additionally, the user is not required to share an account number with the merchant and/or the wallet service because, accordingly to one or more embodiments of the invention, an identifier generated during an earlier payment can be used to uniquely reference the account.

At least one embodiment of the invention can be implemented as a payment gateway feature. By way merely of illustration, a set of online retailers using such a feature through the gateway can be referred to as participating retailers. As such, a participating retailer can allow customers to choose one or more mobile numbers in a related customer profile to utilize for mobile money checkout purposes. Online retailers can, for example, store customer profiles along with corresponding phone numbers. The retailer can also verify that the corresponding device (that is, the device used to make the above-noted selection) is indeed in possession of the user. Such verification can be carried out, for example, by sending a one-time password (OTP) challenge to the device.

Additionally, and as similarly detailed in FIG. 1, a bank instrument can be automatically registered (remembered) when the user makes a first payment using that account number (that is, the account number associated with the noted bank instrument) at any of the participating retailers using a web-based net banking workflow. Such a first payment workflow can allow the gateway to associate a user's/customer's phone number at the retailer with a bank account with which the customer made the payment. However, as noted above, instead of learning the actual account number, the gateway is only aware of a reference to the account. Once thus associated, the user is able to select a mobile money option and choose the instrument with which to carry out a transaction/purchase from any payment app and/or website of any of the participating retailers. The gateway uses the account reference to notify the bank which, in turn, sends a notification and authorization request to the bank app on the user's device (in connection with a transaction/purchase). Further, in connection with one or more embodiments of the invention (and as detailed in FIG. 2), a bank app can be opened automatically on the user's device while routing the authorization request to the bank (which can, for example, improve the user experience).

One or more embodiments of the invention can also be implemented, for example, in connection with scenarios involving credit and/or debit card payments that require bank authentication using a password, as well as a wallet service that requires a login (in both a mobile as well as a web context).

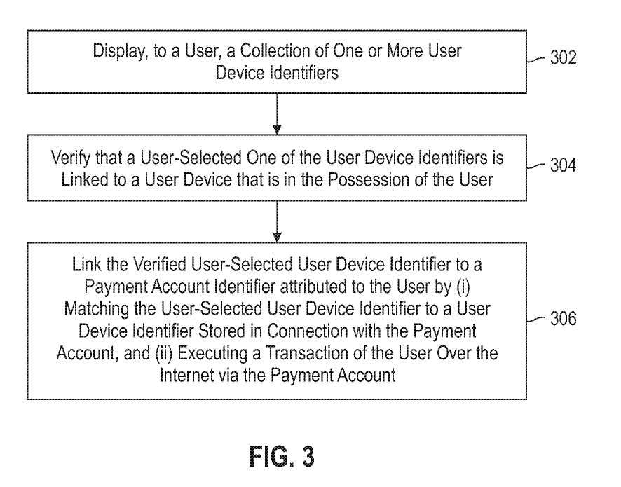

FIG. 3 is a flow diagram illustrating techniques according to an embodiment of the present invention. Step 302 includes displaying, to a user, a collection of one or more user device identifiers. The user device identifiers can include, for example, one or more telephone numbers. Also, in one or more embodiments of the invention, the collection of one or more user device identifiers can be stored in a user profile arising from one of a set of multiple merchants.

Step 304 includes verifying that a user-selected one of the user device identifiers is linked to a user device that is in the possession of the user. The user device can include, for example, a telephone, a mobile telephone, a smart phone, a tablet, etc. Also, verifying can include (i) sending a one-time password to the user device linked to the user-selected user device identifier and (ii) querying the user to return the one-time password.

Step 306 includes linking the verified user-selected user device identifier to a payment account identifier attributed to the user by (i) matching the user-selected user device identifier to a user device identifier stored in connection with the payment account, and (ii) executing a transaction of the user over the Internet via the payment account. Executing the transaction can include executing the transaction at one of a set of multiple merchants. Additionally, in one or more embodiments of the invention, the payment account can include a bank account, a credit card account, and/or a debit card account. Further, the payment account identifier can include a privacy-preserving reference to the payment account of the user.

Also, executing the transaction can include redirecting the user's web browser to a web page of the financial institution that hosts the payment account, and transmitting a payment authorization request to the financial institution in connection with the transaction of the user over the Internet via the payment account, wherein the payment authorization request comprises the verified user-selected user device identifier. At least one embodiment of the invention can further include applying a unique identifier to the payment account subsequent to said executing the transaction of the user over the Internet via the payment account, wherein said unique identifier is generated by the financial institution that hosts the payment account.

The techniques depicted in FIG. 3 can also include querying the user, subsequent to said linking, to confirm that the payment account is to be used as an expedited payment mechanism in one or more future transactions with one or more of a set of multiple merchants. At least one embodiment of the invention can further include attributing a user-modifiable name to the payment account in response to the user confirming that the payment account is to be used as an expedited payment mechanism.

Additionally, as detailed herein, the techniques depicted in FIG. 3 can be implemented, for example, by a payment gateway.

Also, an additional embodiment of the invention includes presenting, to a user, a collection of one or more stored user device identifiers, and verifying that a user-selected one of the user device identifiers is linked to a user device that is in the possession of the user. Such an embodiment can also include linking the verified user-selected user device identifier to a payment account identifier attributed to the user by (i) matching the user-selected user device identifier to a user device identifier stored in connection with the payment account, and (ii) executing a first transaction, between the user and one of multiple merchants, over the Internet via the payment account. Additionally, such an embodiment can include denoting the payment account linked to the verified user-selected user device identifier as an expedited payment mechanism for use in one or more future transactions with one or more of the multiple merchants, and providing the expedited payment mechanism as a payment option in connection with a second transaction between the user and one of the multiple merchants.

Such an embodiment can further include displaying the expedited payment mechanism to the user against a previously verified user device identifier without requiring an explicit authentication from the user. Also, such an embodiment can include initiating a payment request to a financial institution for charging the payment account, resulting in an authorization request for the payment being sent to the user, as well as checking the status of the second transaction via communication with the financial institution and communicating the status to the merchant.

The techniques depicted in FIG. 3 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 3 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

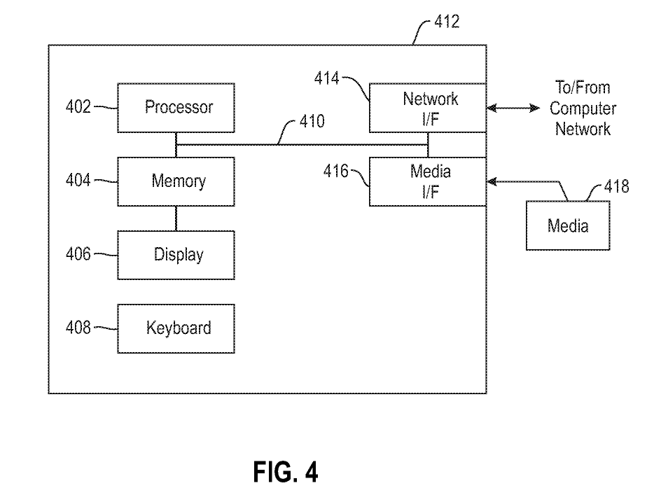

Additionally, an embodiment of the present invention can make use of software running on a computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 402. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, utilizing a user's phone number as a primary identifier during an Internet checkout.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
displaying, to a user, a collection of one or more user device identifiers;
verifying that a user-selected one of the user device identifiers is linked to a user device that is in the possession of the user; and
linking the verified user-selected user device identifier to a payment account identifier attributed to the user by (i) matching the user-selected user device identifier to a user device identifier stored in connection with the payment account, and (ii) executing a transaction of the user over the Internet via the payment account;
wherein the steps are carried out by at least one computing device.

2. The computer-implemented method of claim 1, wherein the one or more user device identifiers comprise one or more telephone numbers.

3. The computer-implemented method of claim 1, wherein the collection of one or more user device identifiers is stored in a user profile arising from one of a set of multiple merchants.

4. The computer-implemented method of claim 1, wherein the user device comprises a mobile telephone.

5. The computer-implemented method of claim 1, wherein said verifying comprises (i) sending a one-time password to the user device linked to the user-selected user device identifier and (ii) querying the user to return the one-time password.

6. The computer-implemented method of claim 1, wherein said executing comprises executing the transaction at one of a set of multiple merchants.

7. The computer-implemented method of claim 1, wherein the payment account comprises one of (i) a bank account, (ii) a credit card account, and (iii) a debit card account.

8. The computer-implemented method of claim 1, wherein the payment account identifier comprises a privacy-preserving reference to the payment account of the user.

9. The computer-implemented method of claim 1, wherein said executing comprises:
redirecting the user's web browser to a web page of the financial institution that hosts the payment account; and
transmitting a payment authorization request to the financial institution in connection with the transaction of the user over the Internet via the payment account, wherein the payment authorization request comprises the verified user-selected user device identifier.

10. The computer-implemented method of claim 9, comprising:
applying a unique identifier to the payment account subsequent to said executing the transaction of the user over the Internet via the payment account, wherein said unique identifier is generated by the financial institution that hosts the payment account.

11. The computer-implemented method of claim 1, comprising:
querying the user, subsequent to said linking, to confirm that the payment account is to be used as an expedited payment mechanism in one or more future transactions with one or more of a set of multiple merchants.

12. The computer-implemented method of claim 11, comprising:
attributing a user-modifiable name to the payment account in response to the user confirming that the payment account is to be used as an expedited payment mechanism.

13. The computer-implemented method of claim 1, wherein the steps are implemented by a payment gateway.

14. A computer program product comprising a computer readable storage medium having program instructions embodied therewith, the program instructions executable by a device to cause the device to:
display, to a user, a collection of one or more user device identifiers;
verify that a user-selected one of the user device identifiers is linked to a user device that is in the possession of the user; and
link the verified user-selected user device identifier to a payment account identifier attributed to the user by (i) matching the user-selected user device identifier to a user device identifier stored in connection with the payment account, and (ii) executing a transaction of the user over the Internet via the payment account.

15. A system comprising:
a memory; and
at least one processor coupled to the memory and configured for:
displaying, to a user, a collection of one or more user device identifiers;
verifying that a user-selected one of the user device identifiers is linked to a user device that is in the possession of the user; and
linking the verified user-selected user device identifier to a payment account identifier attributed to the user by (i) matching the user-selected user device identifier to a user device identifier stored in connection with the payment account, and (ii) executing a transaction of the user over the Internet via the payment account.

16. A computer-implemented method, comprising:
presenting, to a user, a collection of one or more stored user device identifiers;
verifying that a user-selected one of the user device identifiers is linked to a user device that is in the possession of the user;
linking the verified user-selected user device identifier to a payment account identifier attributed to the user by (i) matching the user-selected user device identifier to a user device identifier stored in connection with the payment account, and (ii) executing a first transaction, between the user and one of multiple merchants, over the Internet via the payment account;
denoting the payment account linked to the verified user-selected user device identifier as an expedited payment mechanism for use in one or more future transactions with one or more of the multiple merchants; and
providing the expedited payment mechanism as a payment option in connection with a second transaction between the user and one of the multiple merchants;
wherein the steps are carried out by at least one computing device.

17. The computer-implemented method of claim 16, comprising:
displaying the expedited payment mechanism to the user against a previously verified user device identifier without requiring an explicit authentication from the user.

18. The computer-implemented method of claim 16, comprising:
initiating a payment request to a financial institution for charging the payment account, resulting in an authorization request for the payment being sent to the user.

19. The computer-implemented method of claim 18, comprising:
checking the status of the second transaction via communication with the financial institution; and
communicating the status to the merchant.

20. The computer-implemented method of claim 16, wherein said verifying comprises (i) sending a one-time password to the user device linked to the user-selected user device identifier and (ii) querying the user to return the one-time password.
